(19) United States
(12) Patent Application Publication
(10) Pub. No.: US 2004/0125511 A1
(43) Pub. Date: Jul. 1, 2004

(54) Method and apparatus for fine tuning read/write head on hard disk drive and integrated fabrication process

(75) Inventors: Xiao Yang, Fremont, CA (US); Visit Thaveeprungsriporn, Bangkok (TH); Szu-Han Hu, Bangkok (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, Ayutthaya (TH)

(21) Appl. No.: 10/330,653

(22) Filed: Dec. 26, 2002

(51) Int. Cl. G11B 5/56

(52) U.S. Cl. 360/294.4

(57) ABSTRACT

A method (and apparatus) for operating a disk drive apparatus. The method includes moving a movable member about a fixed position to move a read/write head coupled to a slider to a selected track on a disk. The selected track is at least one of a plurality of tracks. The method includes adjusting a position of the read/write head using an actuating device coupled between the read/write head and the slider. The actuating step moves the read/write head relative in a manner normal to the track on the magnetic disk to align the read/write head on the track using a finer and faster alignment of the read/write head than the moveable support member.

### BACKGROUND OF THE INVENTION

This invention generally relates to techniques for operating a disk drive apparatus. More particularly, the present invention provides a method and apparatus for reading and writing information onto a computer disk commonly called a hard disk for storing data. Merely by way of example, the present invention is implemented using such method and apparatus with an actuating device coupled between a read/write head and support member for fine tuning the read/write head onto a data track on the hard disk, but it would be recognized that the invention has a much broader range of applicability.

Storage of information has progressed through the years. From the early days, primitive man stored information on walls of eaves, as well as used writings on wood such as bamboo. Since then, people have used wood, silk, and papers as a media for writings. Paper has been bound to form books. Information is now stored electronically on disks, tape, and semiconductor devices. As merely an example, some of the early disks used magnetic technology to store bits of information in a digital manner onto the magnetic media. One of the first disk drives was discovered in the 1950's by International Business Machines of Armonk, N.Y.

Although such disks have been successful, there continues to be a demand for larger storage capacity drives. Higher storage capacity can be achieved in part by increasing an aerial density of the disk. That is, the density increases with the number of tracks per inch (TPI) and the number of bits per inch (BPI) on the disk.

As track density increases, however, the data track becomes narrower and the spacing between data tracks on the disk decreases. It becomes increasingly difficult for the motor and servo control system to quickly and accurately position the read/write head over the desired track. Conventional actuator motors, such as voice coil motors (VCM), often lack sufficient resolution and bandwidth to effectively accommodate high track-density disks. As a result, a high bandwidth and resolution second-stage microactuator is often necessary to precisely position the read/write head over a selected track of the disc. Thus, there is a need for an improved drive apparatus.

### SUMMARY OF THE INVENTION

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

In a specific embodiment, the invention provides a disk drive apparatus, e.g., hard disk drive system. The apparatus has a magnetic disk for storing information, which includes a plurality of tracks. The method also includes a movable support member often called Head Gimbal Assembly or HGA coupled to the magnetic disk. The HGA includes a read/write head and a suspension. The suspension is comprised of a trace gimbal or TG and a loadbeam. The gimbal has a tongue portion. A slider device is coupled to the tongue portion. A read/write head is coupled to the slider device. The gimbal has certain stiffness that allows the read/write head to pitch and roll around a pivotal point at the center of the tongue. A drive device is coupled between the magnetic disk and the suspension. The primary drive device, e.g., a voice coil motor or VCM, is adapted to move the read/write head on a track on the magnetic disk using the suspension to suspend the read/write head over the disk at a distance of few nanometers. A second stage actuator device is coupled between the slider device and the read/write head. The actuator device is adapted to move the read/write head relative to the slider device to a position normal to the track on the magnetic disk to align the read/write head on the track using a finer and faster alignment of the read/write head than the moveable support member driven by the VCM.

In an alternative specific embodiment, the invention provides a method for operating a disk drive apparatus. The method includes moving a suspension about a fixed position to move a read/write head coupled to a slider to a selected track on a disk. The selected track is at least one of a plurality of tracks. The method includes correcting off-track error of the read/write head using a second stage actuating device coupled between the read/write head and the slider. The actuating step moves the read/write head relative in a manner normal to the track on the magnetic disk to align the read/write head on the track using a finer and faster alignment of the read/write head than the VCM.

In yet an alternative specific embodiment, the invention includes an apparatus for disk drive. A suspension has a first end and a second end. The first end is connected to an arm that is adapted to couple about a pivot region. The second end includes a tongue portion. A slider is coupled to the tongue portion. The slider is capable to acting as an air bearing and a support member. A read/write head is coupled to the slider. An actuating device is coupled between the read/write head and the slider. The actuating device is capable of moving the read/write head in a manner normal to a track on a magnetic disk to align the read/write head to a desired a track on the track to a tolerance of less than 10 nanometers and at a frequency of greater than 5 kHz.

Numerous benefits are achieved using the present invention over conventional techniques. For example, the present invention can be implemented using existing fabrication technologies. Additionally, the present invention can provide for alignment of a read/write head to track density of 250 k TPI (track per inch) or 100 Gbit/in² and greater at 5 kHz or greater. In certain embodiments, the present invention can be implemented using a small form factor, e.g., less than 100 microns in thickness, which results in no change in disk-disk spacing and causes little additional off-track error from “windage effect.” The invention can also be easy to manufacture and apply according to certain embodiments. Depending upon the embodiment, one or more of these benefits may be used. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified top-view diagram of a disk drive apparatus according to an embodiment of the present invention;

FIG. 2 is a more detailed side-view diagram of a disk drive arm assembly according to an embodiment of the present invention;

FIG. 3 is a detailed diagram of a slider assembly according to an embodiment of the present invention;

FIG. 4 is a detailed diagram of a multiplayer PZT micro actuator assembly, and a slider and head assembly according to an embodiment of the present invention;

FIG. 5 is a detailed diagram of micro actuating device operating modes according to embodiments of the present invention; and

FIG. 6 is a diagram of a plot illustrating bandwidth against devices according to embodiments of the present invention.

### DESCRIPTION OF THE SPECIFIC EMBODIMENTS

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

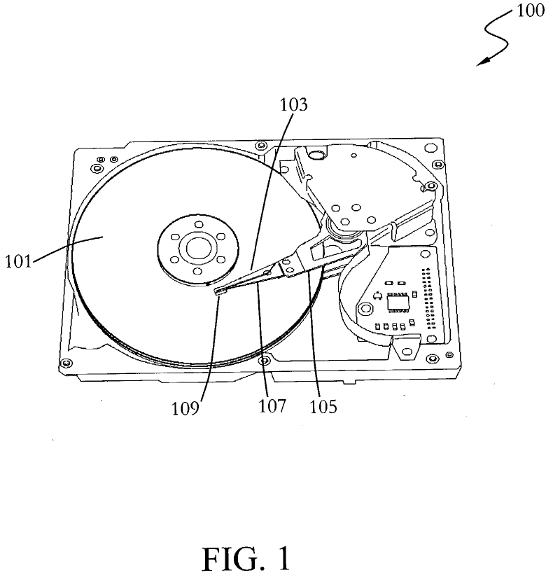

FIG. 1 is a simplified top-view diagram 100 of a disk drive apparatus according to an embodiment of the present invention. This diagram is merely an example, which should not unduly limit the scope of the claims herein. One of ordinary skill in the art would recognize many other variations, modifications, and alternatives. As shown, the apparatus 100 includes various features such as disk 101, which rotates about a fixed axis. The disk also includes tracks, which are used to store information thereon. The disk rotates at 7,200 RPM to greater than about 10,000 depending upon the embodiment. The disk, commonly called a platter, often includes a magnetic media such as a ferromagnetic material, but can also include optical materials, common coated on surfaces of the disk, which become active regions for storing digital bit information. Overlying the disk is head gimbal assembly or HGA 103, which operates and controls a slider 109 coupled to a read/write head. The head gimbal assembly is coupled to suspension 107 which couples to an arm 105. The arm is coupled to a voice coil motor or VCM, which moves the head assembly about a pivot point in an annular manner. The VCM can move at a frequency of up to about 1 kHz. Preferably, for high track density, e.g. 250 k TPI, the speed is at least 5 kHz, but can also be greater in certain embodiments. Further details of the head assembly are provided throughout the present specification and more particularly below.

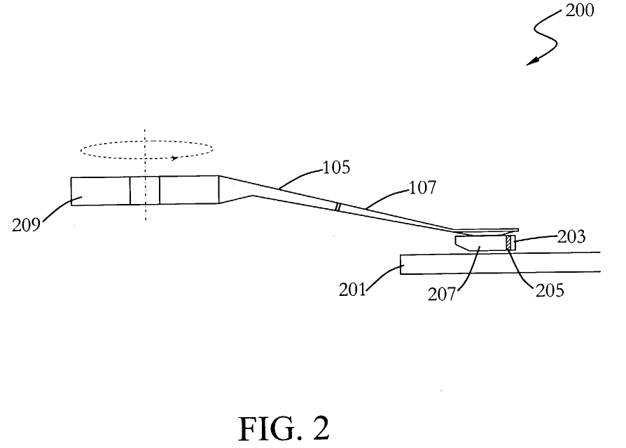

FIG. 2 is a more detailed side-view diagram of a disk drive arm assembly 200 according to an embodiment of the present invention. This diagram is merely an example, which should not unduly limit the scope of the claims herein. One of ordinary skill in the art would recognize many other variations, modifications, and alternatives. Like reference numerals are used in this diagram as certain other diagrams herein, which should not be limiting. As shown, the assembly includes suspension 107 coupled to arm 105 coupled to voice coil motor 209. Slider 207 is coupled to another end of the suspension. The slider includes read/write head 203. The head is positioned over a track on the platter 201, which is among a plurality of tracks on the disk.

Preferably, the head gimbal assembly also includes a micro actuator device 205 coupled between the slider 207 and read/write head 203. The actuating device moves the head in a direction normal to a direction of the track according to a specific embodiment. Preferably, the actuating device is made of a PZT material, which is operable in the shear mode, but can also be in other modes. As merely an example, such PZT material is described in U.S. Ser. No. ______ (021612-000600US), commonly assigned, and hereby incorporated by reference for all purposes.

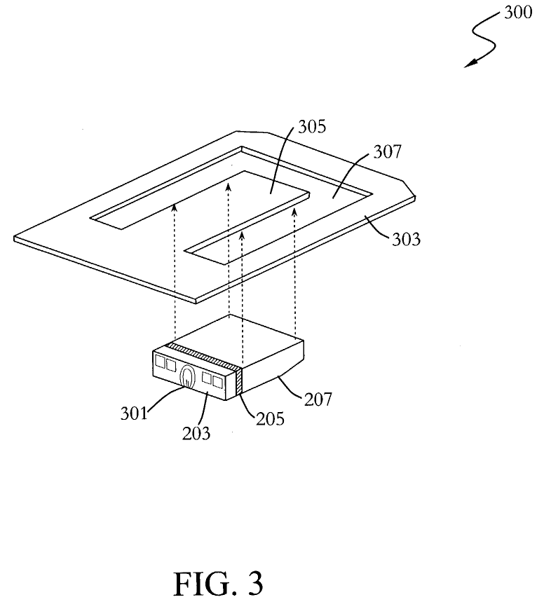

FIG. 3 is a detailed diagram of a slider assembly 300 according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the slider assembly 300 includes slider 207 coupled to actuating device 205. The actuating device is coupled to the read/write head chip 203, which includes active read/write region 301. The slider assembly includes tongue 305 and gimbal 303, which includes opening to provide desired stiffness that allows the slider to pitch and roll. The slider is assembled to the tongue using adhesive material such as UV cure epoxy. The actuating device and the read/write head portion are free to move. Further details of the slider assembly are provided throughout the present specification.

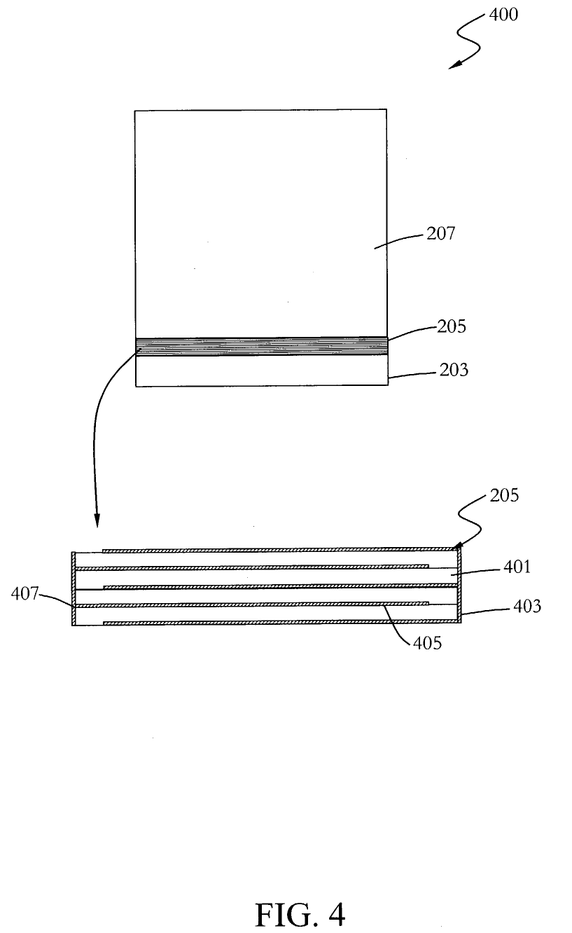

FIG. 4 is a detailed diagram of a slider and head assembly 400 according to an embodiment of the present invention. This diagram is merely an example, which should not unduly limit the scope of the claims herein. One of ordinary skill in the art would recognize many other variations, modifications, and alternatives. As shown, the slider assembly 400 includes slider 207 coupled to actuating device 205. The actuating device is coupled to head 203, which includes active region. The actuating device includes a plurality of thin film PZT layers, which are coupled to each other. Each of the layers 401 includes separating electrodes 405. One end of the electrodes is coupled to common electrode 403 and the other end of the electrodes is coupled common electrode 407 with opposite polarity. As noted, further details of the slider assembly are provided throughout the present specification.

A method according to an embodiment of the present invention may be outlined as follows:

1. Provide an improved disk drive apparatus;

2. Move a movable member about a fixed position to move a read/write head coupled to a slider to a selected track on a disk;

3. Adjust a position of the read/write head using an actuating device coupled between the read/write head and the slider, whereupon the actuating step moves the read/write head relative in a manner normal to the track on the magnetic disk;

4. Position the read/write head on the track using a finer and more accurate alignment than the primary actuating device such as a VCM;

5. Position the read/write head on the track using a faster alignment than the primary actuating device such as a VCM; and

6. Perform other steps, as desired.

The above sequence of steps provides a method according to an embodiment of the present invention. As shown, the method includes using an actuating device coupled between the read/write head and the slider to provide fine and quick alignment of the read/write head onto the disk track. Further details of the method are provided throughout the present specification and more particularly below.

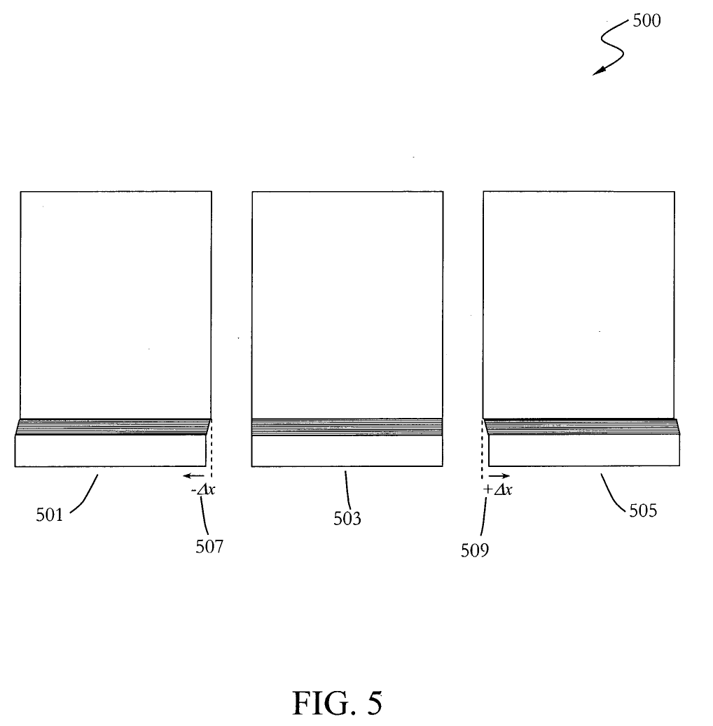

FIG. 5 is a detailed diagram of a micro actuating device operating modes 500 according to embodiments of the present invention. This diagram is merely an example, which should not unduly limit the scope of the claims herein. One of ordinary skill in the art would recognize many other variations, modifications, and alternatives. As shown, the diagram includes various embodiments 501, 503, 505, which relate to changes in position based upon various actuation modes of the actuating device according to a method of the present invention. More particularly, the method includes adjusting a position of the read/write head using an actuating device coupled between the read/write head and the slider. The actuating step moves the read/write head relative in a manner normal to the track on the magnetic disk to align the read/write head on the track using a finer and faster alignment of the read/write head than the VCM. The head may move in a negative x-direction, as shown by reference numeral 507. The head can also be in a center position 503. Alternatively, the head may move in a positive x-direction, as shown by reference numeral 509.

Additional degree of freedom (DOF) of the read/write head can be obtained by stacking additional pzt element with different poling orientation. As merely an example, the read/write head can be moved vertical relative to the track on the magnetic disk to adjust flying height in operation.

Depending upon the embodiment, the actuation can include a series of discrete steps or be continuous such as analog. As merely an example, the steps can be about few nanometers (e.g., 2-4) and less depending upon the embodiment. Alternatively, the steps can be continuous or combined with continuous motion depending upon the embodiment. A characteristic time for moving the head can be about 0.2 to 0.1 microseconds but can also be greater, depending upon the application. Depending upon the embodiment, there can be other ways of illustrating the actuating device time characteristic, as illustrated by the FIG. 7.

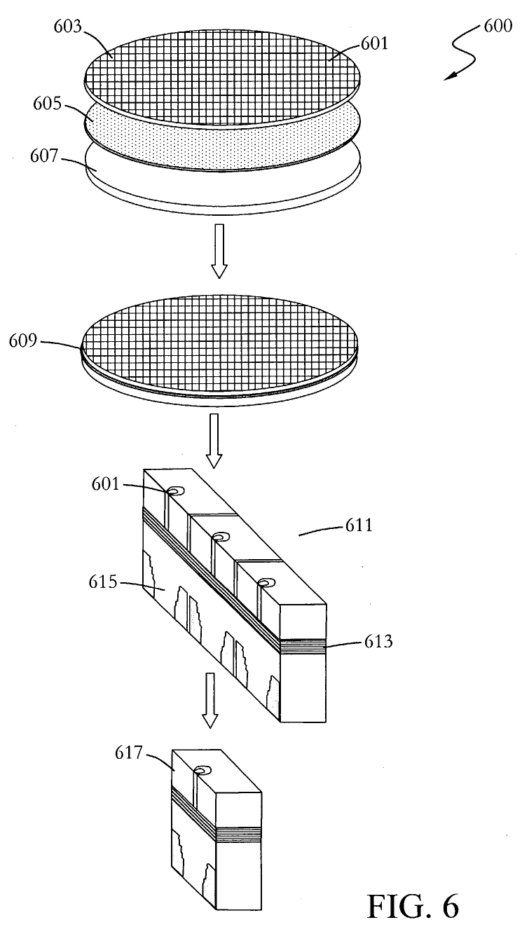

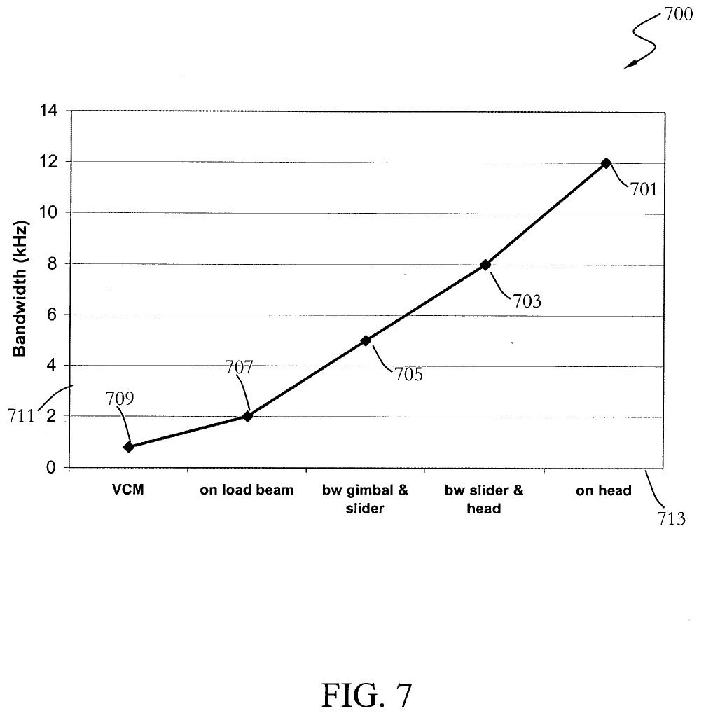

FIG. 6 is a detailed manufacturing process flow diagram of the read/write head, actuating device and slider assembly 600 according to embodiments of the present invention. This diagram is merely an example, which should not unduly limit the scope of the claims herein. One of ordinary skill in the art would recognize many other variations, modifications, and alternatives. As shown, the diagram includes an integrated wafer-level fabrication method of the read/write head, actuating device and the slider. More particularly, a plurality of read/write head elements 601 are fabricated on the read/write head wafer 603. The actuating device wafer 605 is fabricated and then bonded to the slider substrate wafer 607. Preferably, the actuating device is made of multi layer PZT thin film material, but can also be other micro actuating devices such as electrostatic actuated combdrive. Depending upon the embodiment, the actuating device can be directly fabricated on the surface of the slider wafer. As merely an example, PZT materials can be sputtered or printed onto the surface of the slider wafer; a combdrive structure can also be formed by etching into the slider wafer.

The read/write head wafer is then bonded to the slider substrate wafer to form a composite wafer 609 with the actuating device layer sandwiched in between. The composite wafer is then diced into arrays of slider assembly 611 with the actuating device layer in between 613. A lapping process is preceded to expose the read/write head element 601, followed by air bearing formation 615. Finally, individual chip is separated 617 by dicing process. Further details of the method are provided throughout the present specification and more particularly below.

FIG. 7 is a diagram of a plot illustrating bandwidth against devices according to embodiments of the present invention. This diagram is merely an example, which should not unduly limit the scope of the claims herein. One of ordinary skill in the art would recognize many other variations, modifications, and alternatives. As shown, the plot includes bandwidth along the vertical axis 711, which intersects with location of the actuating devices. Such locations include a voice coil motor 709, micro actuator on load beam 707, micro actuator between a gimbal and slider 705, microactuator between a slider and head 703, and micro actuator integrated on the read/write head 601. The present embodiment describes the devices illustrate by reference numeral and 703. Other aspects of such devices are provided in U.S. Ser. No. ______(021612-000600US), commonly assigned, and hereby incorporated by reference for all purposes.

One of ordinary skill in the art would recognize many other variations, modifications, and alternatives. The above example is merely an illustration, which should not unduly limit the scope of the claims herein. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A disk drive apparatus, the apparatus comprising:
a magnetic disk for storing information, the magnetic disk comprising a plurality of tracks;
a movable support member coupled to the magnetic disk, the movable support member having a tongue portion and a gimble portion, the tongue portion being coupled the gimbal portion;
a slider device coupled to the tongue portion;
a read/write head coupled to the slider device;
a drive device coupled between the magnetic disk and the movable support member, the drive device being adapted to move the read/write head on a track on the magnetic disk using the movable support member about a fixed pivot position; and
an actuator device coupled between the slider device and the read/write head, the actuator device being adapted to move the read/write head relative to the slider device to a position normal to the track on the magnetic disk to align the read/write head on the track using a finer alignment of the read/write head than the moveable support member.

2. The apparatus of claim 1 wherein actuator device is a piezoelectric material coupled between the slider device and the read/write head.

3. The apparatus of claim 1 wherein actuator device uses an electrostatic force to move the read/write head.

4. The apparatus of claim 3 wherein the actuator device comprises a comb drive.

5. The apparatus of claim 1 wherein the drive device is a voice coil motor.

6. The apparatus of claim 1 wherein movable support member is provided in a suspension assembly.

7. The apparatus of claim 1 wherein the actuating device is a piezoelectric material, the piezoelectric material being adapted to working in a shear mode to allow the read/write head to move relative to the slider device.

8. The apparatus of claim 7 wherein the piezoelectric material comprises a plurality of piezoelectric material layers, the plurality of piezoelectric material layers include N layers, where N is an integer.

9. The apparatus of claim 8 wherein the piezoelectric material moves the read/write head by a distance x defined by N*V*d₁₅, where V is an applied voltage and d₁₅ is shear mode piezoelectric coefficient.

10. The apparatus of claim 1 wherein the actuating device comprises a first comb member operably coupled to a second comb member, the first comb member being connected to the read/write head, the second comb member being connected to the slider device, the first comb member being adapted to move towards the second comb member via electrostatic force applied between the first comb member and the second comb member to allow the read/write head to move.

11. A method for operating a disk drive apparatus, the method comprising:
moving a movable member about a fixed position to move a read/write head coupled to a slider to a selected track on a disk, the selected track being at least one of a plurality of tracks;
adjusting a position of the read/write head using an actuating device coupled between the read/write head and the slider, whereupon the actuating moves the read/write head relative in a manner normal to the track on the magnetic disk to align the read/write head on the track using a finer alignment of the read/write head than the moveable support member; and
adjusting a position of the read/write head using an actuating device coupled between the read/write head and the slider, whereupon the actuating device moves the read/write head relative in a manner vertical to the track on the magnetic disk to adjust a flying height of the read/write head on the magnetic disk.

12. The method of claim 11 wherein the actuating device moves the read/write head in the manner normal to the track at a distance of less than one micron.

13. The method of claim 11 wherein the actuating device moves the read/write head in a manner normal to the track at a distance of less than one micron and a frequency of greater than 5 kHz.

14. The method of claim 11 wherein the selected track is equal or less than 0.25 micron.

15. The method of claim 11 wherein the disk is rotatable at about 7,200 revolutions per minute and greater.

16. The method of claim 11 wherein the disk is rotatable at about 10,000 revolutions per minute and greater.

17. The method of claim 11 wherein movable member is operable at a frequency of less than 1 kilohertz.

18. The method of claim 11 wherein the actuating device uses either electrostatic force or piezoelectric force or electromagnetic force.

19. The method of claim 11 wherein the actuating device comprises a piezoelectric material, the piezoelectric material being adapted to work in a shear mode to allow the read/write head to move relative to the slider device, the piezoelectric material comprising a plurality of piezoelectric material layers, the plurality of piezoelectric material layers include N layers, where N is an integer;
whereupon the piezoelectric material moves the read/write head by a distance x defined by N*V*d₁₅, where V is an applied voltage and d₁₅ is shear mode piezoelectric coefficient.

20. An apparatus for disk drive, the apparatus comprising:
a movable member having a first end and a second end, the first end being adapted to coupled about a pivot region, the second end including a tongue portion;
a slider coupled to the tongue portion, the slider being capable to acting as an air bearing and a support member;
a read/write head coupled to the slider;
an actuating device coupled between the read/write head and the slider, whereupon the actuating device is capable of moving the read/write head in a manner normal to a track on a magnetic disk to align the read/write head on the track to a tolerance of one micron or less and at a frequency of 3 kHz or greater.

21. The apparatus of claim 20 wherein the actuating device is selected from a piezoelectric material or an electrostatic drive device.
